(19) United States
(12) Patent Application Publication
(10) Pub. No.: US 2025/0353534 A1
(43) Pub. Date: Nov. 20, 2025

(54) DOUBLE-LAYER FOLDING TRAILER THAT DOES NOT INCREASE IN HEIGHT

(71) Applicant: Wuyi County Haiqiu Technology Co., Ltd., Jinhua (CN)

(72) Inventor: QINGYUAN WU, Bozhou (CN)

(21) Appl. No.: 18/762,746

(22) Filed: Jul. 3, 2024

(30) Foreign Application Priority Data
May 17, 2024 (CN) 202421077411.6

(51) Int. Cl. B62B 3/02; B62B 3/00

(52) U.S. Cl. CPC B62B 3/025; B62B 3/007; B62B 2205/06

(57) ABSTRACT

This application concerns a double-layer folding trailer in the field of folding trailers, designed to maintain its height during the folding process. The trailer incorporates four vertical poles, each outfitted with an upper fixed sleeve and a lower fixed sleeve, alongside a sliding sleeve that allows for adjustable positioning. The structure includes left, right, front, and back cross sections that connect the upper fixed sleeves to the sliding sleeves, which stabilizes the setup. Central to the trailer's design is an upper base support section featuring a first and a second base support crossbar, both pivotally connected to base support connectors. These crossbars link to the lower fixed sleeves on opposite sides, facilitating a compact fold. This configuration not only prevents height increase during folding but also minimizes the required storage space, while improving the trailer's load-bearing capacity and overall structural stability.

### CROSS-REFERENCE TO RELATED APPLICATIONS

This application claims priority to Chinese Patent Application No. 202421077411.6, filed on May 17, 2024, which is hereby incorporated by reference in its entirety.

### TECHNICAL FIELD

This application relates to the field of folding trailers, specifically concerning a double-layer folding trailer that does not increase in height.

### BACKGROUND

Trailers are convenient to operate, lightweight, and capable of functioning in places where motor vehicles are impractical, making them very convenient for short-distance transport of lighter items. Most general four-wheel trailers have a cargo platform, and to obtain greater cargo space, double-layer trailers have also been developed.

To facilitate easier storage, most trailers employ a structure with multiple crossing bars that can fold. Applying this structure to double-layer trailers results in foldable double-layer trailers. However, for such trailers, the top part rises after folding, which still requires a substantial storage space. Therefore, it is necessary to install sliding sleeves at the joints of the side crossing bars that can move up and down, ensuring the trailer's top does not rise after folding. However, the installation of these sliding sleeves undoubtedly reduces the load-bearing capacity of the upper cargo platform and also decreases structural stability.

The technical problem this application aims to solve is: how to ensure that the double-layer trailer maintains a strong load-bearing capacity while still possessing a structure that does not rise in height after folding.

### SUMMARY

To overcome the shortcomings of existing technology, the objective of this application is to provide a trailer with a double-layer cargo platform that does not increase in height after folding and has higher structural stability.

The technical solution adopted in this application involves a double-layer folding trailer that includes four vertical poles. Each pole is sequentially equipped from top to bottom with an upper fixed sleeve and a lower fixed sleeve fixed to the pole, as well as a sliding sleeve that is connected to the pole through sliding. Between adjacent poles, there are left and right cross sections and front and back cross sections. The upper ends of these cross sections are connected to the upper fixed sleeve, and their lower ends are connected to the sliding sleeve. Additionally, the middle part of the four poles includes an upper base support section, which comprises a first base support crossbar, a second base support crossbar, and base support connectors. The first and second base support crossbars are pivotally connected to either side of the base support connectors. The first base support crossbar connects to the two lower fixed sleeves on one side, while the second base support crossbar connects to the two lower fixed sleeves on the opposite side.

When the four vertical poles are moved towards the center, the bottoms of the left and right cross sections move downward along with the sliding of the sliding sleeve, while their tops remain at the same height as the upper fixed sleeve. Similarly, the bottoms of the front and back cross sections also move downward with the sliding sleeve, while their tops stay level with the upper fixed sleeve. This structure achieves the technical effect of not increasing in height when folded. During the folding process, the center of the upper base support section moves upward, and it is fixed to the outside of the poles through the lower fixed sleeves, while the lower fixed sleeves are separated from the sliding sleeves and fixed to the poles. This not only ensures the folding effect but also enhances the load-bearing capacity of the upper base support section.

In some embodiments, four vertical poles form a rectangular structure, with the left-right cross sections located on the left and right sides of the rectangle formed by the four vertical poles, and the front-back cross sections located on the front and rear sides of the rectangle.

In some embodiments, the left-right cross section includes a main left-right cross bar, a first cross sub-bar, and a second cross sub-bar. The main left-right cross bar has a V-shaped structure, and its ends are connected inside two upper fixing sleeves. One end of the first cross sub-bar is connected to a slider on one side and the other end to the main left-right cross bar. One end of the second cross sub-bar, distant from the first cross sub-bar, is connected inside a slider on the opposite side, and the other end connects to the main left-right cross bar.

In some embodiments, the ends of the first and second cross sub-bars, which are close to each other, are rotatably connected.

In some embodiments, the front-back cross section includes a first front-back cross bar and a second front-back cross bar. Both cross bars have the same structure and are symmetrically distributed about the central point of the upper fixing sleeves and sliders.

In some embodiments, the ends of the first front-back cross bar are connected to two upper fixing sleeves, while the ends of the second front-back cross bar are connected to two sliders. The first and second front-back cross bars are rotatably connected.

In some embodiments, the first base support cross bar and the second base support cross bar have the same structure and are axially symmetrically distributed about the center point of the base support connector.

In some embodiments, each vertical pole has a base fixing sleeve attached at the bottom, and in the middle of the four base fixing sleeves is the lower base support section, which includes the first lower base cross bar, the second lower base cross bar, and a lower base connector. The first lower base cross bar connects to two base fixing sleeves on one side, and the second lower base cross bar connects to two base fixing sleeves on the opposite side. Both the first and second lower base cross bars are rotatably connected to the two sides of the lower base connector.

In some embodiments, the first and second base support cross bars are of the same length and are shorter than the lengths of the first and second lower base cross bars. The length of the lower base connector is shorter than that of the base support connector.

The beneficial effects of this application include: the use of sliders that can move up and down along the vertical poles ensures that the top does not rise during the folding and collapsing process of the left-right and front-back cross sections, thereby reducing the space required for storage. Additionally, by shortening the lengths of the first and second base support cross bars and increasing the length of the base support connector, the height increase of the base support connector is minimized. This allows for the structure to be folded without elevation even without a sliding connection to the vertical poles. Furthermore, the fixed structure enhances its load-bearing capacity and the structural stability of the upper base support section.

### BRIEF DESCRIPTION OF DRAWINGS

FIG. 1: A three-dimensional schematic diagram of the application;

FIG. 2: A front view schematic diagram of the application;

FIG. 3: A right view schematic diagram of the application;

FIG. 4: Atop view schematic diagram of the application;

FIG. 5: A schematic diagram of the structure after folding.

In the diagrams: 1. Vertical pole; 11. Upper fixing sleeve; 12. Lower fixing sleeve; 13. Slider; 14. Base fixing sleeve; 2. Left-right cross section; 21. Main left-right cross bar; 22. First cross sub-bar; 23. Second cross sub-bar; 3. Front-back cross section; 31. First front-back cross bar; 32. Second front-back cross bar; 4. Upper base support section; 41. First base support cross bar; 42. Second base support cross bar; 43. Base support connector; 5. Lower base support section; 51. First lower base cross bar; 52. Second lower base cross bar; 53. Lower base connector.

### DETAILED DESCRIPTION OF THE EMBODIMENTS

The following provides a clear and complete description of the technical solution in the embodiments of this application, in conjunction with the accompanying drawings in the embodiments. It is evident that the described embodiments are only some of the many possible implementations of this application and not all of them. Based on the embodiments in this application, all other implementations obtained by those skilled in the art without creative efforts are within the scope of protection sought by this application.

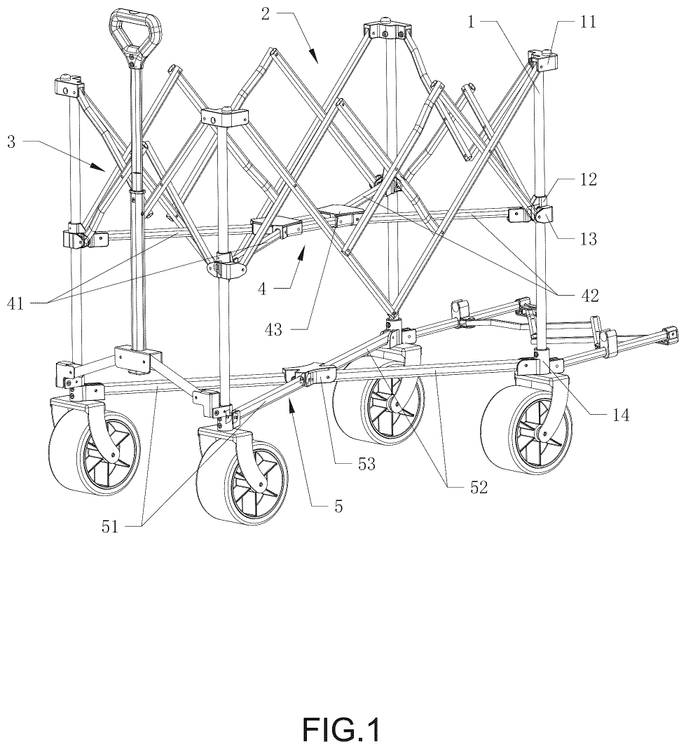

Refer to FIG. 1, the application provides a technical solution: a double-layer folding trailer that does not rise in height, which includes four vertical poles 1 forming a rectangular structure. Each vertical pole 1 is sequentially equipped from top to bottom with an upper fixing sleeve 11, a lower fixing sleeve 12, a slider 13, and a base fixing sleeve 14. The upper fixing sleeve 11 and lower fixing sleeve 12 are fixed to the top and middle of the vertical pole 1, respectively. The slider 13 is slidingly connected to the vertical pole 1 and is located below the lower fixing sleeve 12. The base fixing sleeve 14 is fixed at the bottom of the vertical pole 1. A left-right cross section 2 is set between two vertical poles 1 that are farther apart, and a front-back cross section 3 is set between two vertical poles 1 that are closer together. An upper base support section 4 is located in the middle of the four vertical poles 1, and a lower base support section 5 is at the bottom of the four vertical poles 1.

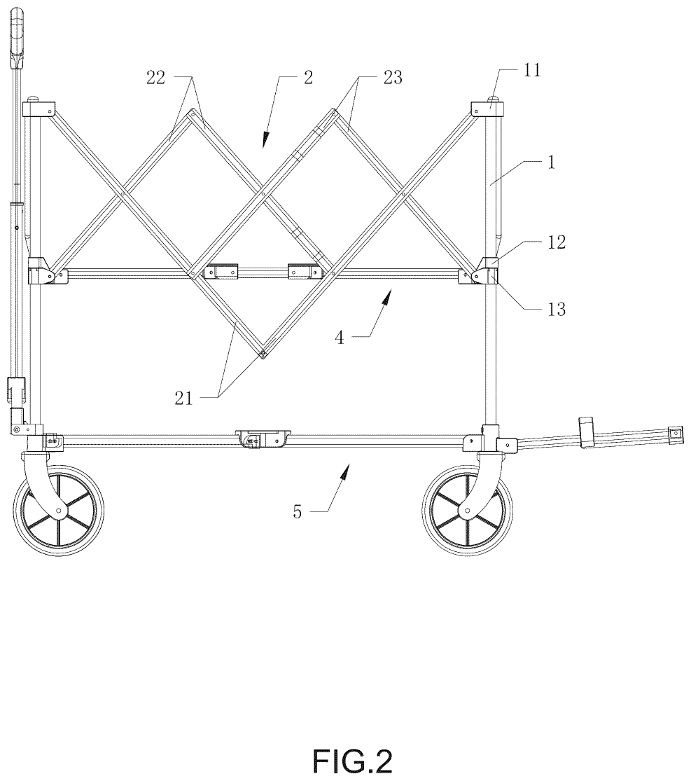

Refer to FIGS. 1 and 2, the left-right cross section 2 includes a main left-right cross bar 21, a first cross sub-bar 22, and a second cross sub-bar 23. Each of these bars is composed of two metal rods connected by a pin. The main left-right cross bar 21, which has a V-shaped structure, is connected at its ends to two upper fixing sleeves 11. The first cross sub-bar 22 is connected at one end inside the slider 13, and its other end connects to the main left-right cross bar 21. Similarly, one end of the second cross sub-bar 23 is connected inside another slider 13, with its other end also connecting to the main left-right cross bar 21.

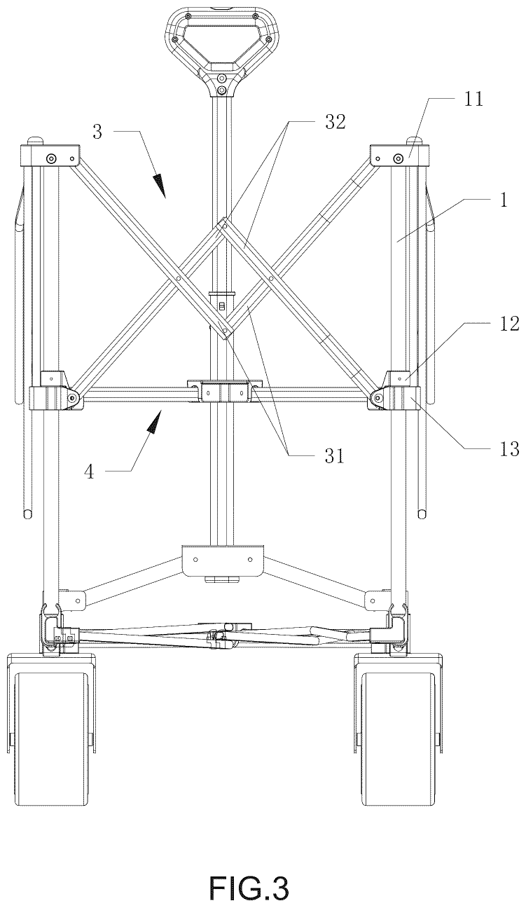

Refer to FIGS. 1 and 3, the front-back cross section 3 includes a first front-back cross bar 31 and a second front-back cross bar 32. Both cross bars 31 and 32 have identical structures and are axially symmetrically distributed about the center point of the upper fixing sleeves 11 and sliders 13. The ends of the first front-back cross bar 31 connect to two upper fixing sleeves 11, while the ends of the second front-back cross bar 32 connect to two sliders 13. Both the first front-back cross bar 31 and the second front-back cross bar 32 are rotatably connected.

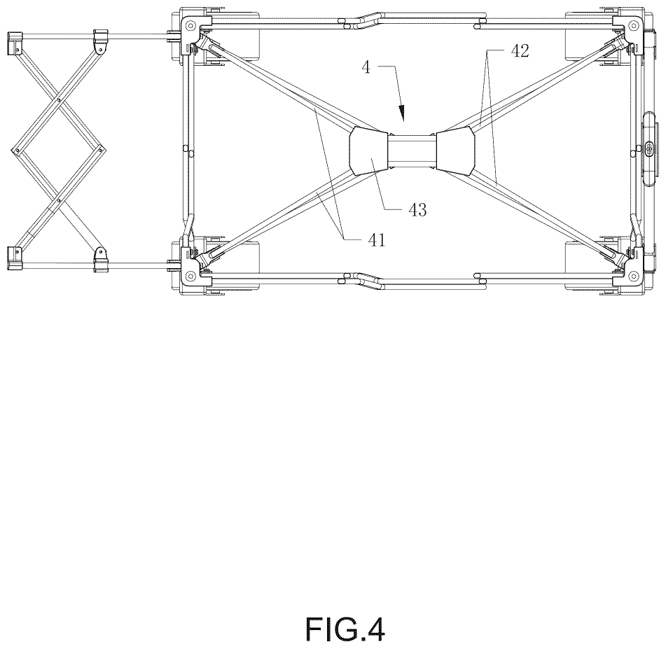

Refer to FIGS. 1 and 4, the upper base support section 4 includes a first base support cross bar 41, a second base support cross bar 42, and a base support connector 43. The first base support cross bar 41 and the second base support cross bar 42 have the same structure and are symmetrically distributed about the center point of the base support connector 43. The first base support cross bar 41 connects to two lower fixing sleeves 12 on one side, while the second base support cross bar 42 connects to two lower fixing sleeves 12 on the opposite side. Both the first base support cross bar 41 and the second base support cross bar 42 are rotatably connected to the two sides of the base support connector 43.

Refer to FIGS. 1 and 4, the lower base support section 5 includes a first lower base cross bar 51, a second lower base cross bar 52, and a lower base connector 53. The first lower base cross bar 51 and the second lower base cross bar 52 have identical structures and are symmetrically distributed about the center point of the lower base connector 53. The first lower base cross bar 51 connects to two base fixing sleeves 14 on one side, and the second lower base cross bar 52 connects to two base fixing sleeves 14 on the opposite side. Both the first lower base cross bar 51 and the second lower base cross bar 52 are rotatably connected to the two sides of the lower base connector 53. Additionally, the shapes of the first base support cross bar 41 and the second base support cross bar 42 are consistent with those of the first lower base cross bar 51 and the second lower base cross bar 52. The key difference lies in their lengths: the first base support cross bar 41 and the second base support cross bar 42 are shorter than the first lower base cross bar 51 and the second lower base cross bar 52. During folding, the elevation height of the first base support cross bar 41 and the second base support cross bar 42 is less than that of the first lower base cross bar 51 and the second lower base cross bar 52. This ensures that the highest point of the trailer does not increase in height when folded. The length of the lower base connector 53 is greater than that of the base support connector 43. Additionally, the base support connector 43 is composed of plastic parts on both sides connected to a central metal tube, whereas the lower base connector 53 is made entirely of plastic, ensuring structural stability when the longer base support connector 43 bears heavy loads.

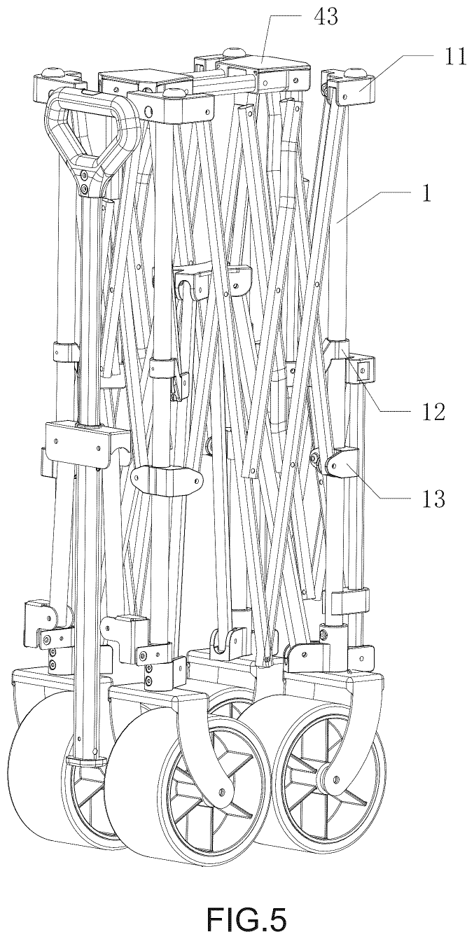

Refer to FIGS. 1 and 5, which illustrate the folding principle and usage process of the application. During folding, the base support connector 43 is first lifted upwards, causing the midpoint of the crossing of the first base support cross bar 41 and the second base support cross bar 42 to move upwards. This action, influenced by the traction at the four corners of the first and second base support cross bars, pulls the four vertical poles 1 towards the center. This movement causes the midpoint of the main left-right cross bar 21 to move downwards, and simultaneously, drives the first cross sub-bar 22 and the second cross sub-bar 23 to fold crosswise. Due to the presence of the sliders 13, the top height of the two cross sub-bars remains unchanged. As the sliders 13 move downward, the increased height at the bottom during the crossing ensures that the highest point always remains level with the upper fixing sleeve 11. The folding principle of the front-back cross section 3 is the same as described above.

Finally, It should be noted that the foregoing descriptions are merely preferred examples of this application and are not intended to limit the scope of this application. Despite the detailed explanation of the application provided with reference to the preceding embodiments, those skilled in the art can still modify the technical solutions described in these embodiments, or equivalently substitute some of the technical features. Any modification, equivalent substitution, or improvement made within the spirit and principles of this application should be included within the scope of protection of this application.

What is claimed is:

1. A double-layer folding trailer that does not increase in height, comprising four vertical poles (1), characterized in that each vertical pole (1) is sequentially equipped from top to bottom with an upper fixed sleeve (11) and a lower fixed sleeve (12) fixed to the pole, and a sliding sleeve (13) that is slidably connected to the pole. Between adjacent vertical poles (1), there are left and right cross sections (2) and front and back cross sections (3). The upper ends of the left and right cross sections (2) and the front and back cross sections (3) are connected to the upper fixed sleeve (11), and their lower ends are connected to the sliding sleeve (13). The middle part of the four vertical poles (1) also includes an upper base support section (4), which comprises a first base support crossbar (41), a second base support crossbar (42), and base support connectors (43). The first base support crossbar (41) and the second base support crossbar (42) are pivotally connected to the two sides of the base support connector (43), respectively. The first base support crossbar (41) connects to the two lower fixed sleeves (12) on one side, and the second base support crossbar (42) connects to the two lower fixed sleeves (12) on the other side.

2. The double-layer folding trailer according to claim 1, characterized in that the four vertical poles (1) form a rectangular structure, with the left and right cross sections (2) located on the left and right sides of the rectangular structure formed by the four vertical poles (1), and the front and back cross sections (3) located on the front and back sides of the rectangular structure formed by the four vertical poles (1).

3. The double-layer folding trailer according to claim 2, characterized in that the left and right cross sections (2) include a left and right main crossbar (21), a first auxiliary crossbar (22), and a second auxiliary crossbar (23). The left and right main crossbar (21) is V-shaped, with its ends each connected inside two upper fixed sleeves (11). The first auxiliary crossbar (22) is connected at one end to a sliding sleeve (13) on one side and at the other end to the left and right main crossbar (21). The second auxiliary crossbar (23), distant from the first auxiliary crossbar (22), is connected at one end inside the sliding sleeve (13) on the other side, and at the other end to the left and right main crossbar (21).

4. The double-layer folding trailer according to claim 3, characterized in that the ends of the first auxiliary crossbar (22) and the second auxiliary crossbar (23) that are close to each other are pivotally connected.

5. The double-layer folding trailer according to claim 2, characterized in that the front and back cross sections (3) include a first front-to-back crossbar (31) and a second front-to-back crossbar (32). The structures of the first front-to-back crossbar (31) and the second front-to-back crossbar (32) are identical and symmetrically distributed about the central points of the upper fixed sleeve (11) and the sliding sleeve (13).

6. The double-layer folding trailer according to claim 5, characterized in that the ends of the first front-to-back crossbar (31) are each connected to two upper fixed sleeves (11), and the ends of the second front-to-back crossbar (32) are each connected to two sliding sleeves (13). The first front-to-back crossbar (31) and the second front-to-back crossbar (32) are pivotally connected.

7. The double-layer folding trailer according to claim 1, characterized in that the first base support crossbar (41) and the second base support crossbar (42) have identical structures and are symmetrically distributed about the central point of the base support connector (43).

8. The double-layer folding trailer according to claim 1, characterized in that each of the vertical poles (1) is fixedly equipped with a bottom fixed sleeve (14) at its base. In the middle of the four bottom fixed sleeves (14) is a lower base support section (5), which includes a first lower base crossbar (51), a second lower base crossbar (52), and a lower base connector (53). The first lower base crossbar (51) connects to the two bottom fixed sleeves (14) on one side, and the second lower base crossbar (52) connects to the two bottom fixed sleeves (14) on the other side. The first lower base crossbar (51) and the second lower base crossbar (52) are pivotally connected to the two sides of the lower base connector (53).

9. The double-layer folding trailer according to claim 8, characterized in that the lengths of the first upper base crossbar (41) and the second upper base crossbar (42) are the same and both are shorter than the lengths of the first lower base crossbar (51) and the second lower base crossbar (52). The length of the lower base connector (53) is shorter than the length of the upper base connector (43).
